(19) United States
(12) Patent Application Publication
(10) Pub. No.: US 2026/0274311 A1
(43) Pub. Date: Sep. 17, 2026

(54) IN-MOTION TRACK STIFFNESS CHANGE DETECTION

(71) Applicant: UNIVERSITY OF SOUTH CAROLINA, COLUMBIA, SC (US)

(72) Inventors: DIMITRIOS C RIZOS, COLUMBIA, SC (US); REZA NASERI, COLUMBIA, SC (US); BRENNAN L GEDNEY, COLUMBIA, SC (US)

(21) Appl. No.: 19/561,716

(22) Filed: Mar. 10, 2026

Related U.S. Application Data
(60) Provisional application No. 63/858,560, filed on Aug. 6, 2025.
(60) Provisional application No. 63/771,059, filed on Mar. 13, 2025.

(51) Int. Cl. B61K 9/08; B61L 25/02; G01M 5/00

(52) U.S. Cl. CPC B61K 9/08; B61L 25/025; G01M 5/0058

(57) ABSTRACT

A system and method for railway track condition monitoring detects track stiffness variations using dynamic responses obtained from in-service trains. Field data is collected while a railcar is in motion along a track using at least one accelerometer attached to a railcar axle box. Associated GPS information of the railcar is synchronously recorded. The collected axle box acceleration field data is processed for dynamic response analysis using hybrid signal processing to detect the track stiffness changes in the rail system. The hybrid signal processing algorithm identifies and classifies the track stiffness changes from multiple directions, such as vertical and lateral acceleration records obtained from the onboard sensors.

### PRIORITY CLAIM

The present application claims the benefit of priority of U.S. Provisional Patent Application No. 63/771,059, filed Mar. 13, 2025, titled In-Motion System for Track Stiffness Change Detection, and the benefit of priority of U.S. Provisional Patent Application No. 63/858,560, filed Aug. 6, 2025, titled In-Motion Track Stiffness Change Detection, and both of which U.S. Provisional Patent Applications are fully incorporated herein by reference for all purposes.

### STATEMENT REGARDING FEDERALLY SPONSORED RESEARCH OR DEVELOPMENT

This invention was made with government support under 69A3552348340 awarded by the U.S. Department of Transportation. The government has certain rights in the invention.

### BACKGROUND OF THE PRESENTLY DISCLOSED SUBJECT MATTER

Structural health monitoring (SHM) exists as a tool in conjunction with complex structural systems, some of which are related to the transportation infrastructure.

Given the total length of the railway network in the United States surpassing 250,000 km and still expanding fast, effective monitoring of track stiffness emerges as a critical imperative for ensuring railway safety and efficiency [1]. Variations in track stiffness serve as key indicators of potential defects or deterioration within railway infrastructure [2]. This poses risks to passenger safety and operational reliability [3, 4]. Consequently, the need for comprehensive track stiffness monitoring throughout the railway track life cycle is evident. Current methods lack the capability to offer regular and thorough monitoring across the network, leading to periodic maintenance scheduling. However, this infrequent maintenance approach not only increases unsafe transportation risks but also disrupts railway operations [5]. This emphasizes the importance of implementing effective health monitoring systems. Such systems are vital for optimizing railway system functionality and mitigating risks associated with track stiffness variations.

The most common method for inspecting railway stiffness changes is visual inspection, either through manual operation or image processing [6]. Even though it is costly and time-consuming, it is effective in detecting surface stiffness-related defects, including broken sleepers and missing fasteners. It is not feasible, however, to identify loose fasteners and damaged ballast under sleepers. Ultrasonic testing is another method used for stiffness change inspection [7], which can be easily conducted by a specific inspection vehicle. Ground Penetrating Radar (GPR) is capable of evaluating the ballasted track bed condition, which is similar to the ultrasonic pulse-echo technique by using electromagnetic waves instead of ultrasonic waves [8]. Recent developments in sensing technology [9] and computational power have provided new opportunities to improve railway track monitoring strategies and reduce inspection costs. Vibration-based sensors are commonly used to monitor dynamic behavior, which can indicate defects [10-13]. The installation of vibrational sensors directly on tracks usually provides useful information about their condition, but instrumenting the entire railway network is not feasible and would be extremely expensive [5]. In recent years, several studies have presently disclosed the installation of sensors on a passing train for track health monitoring [12, 14, 15]. In addition to not disrupting normal service, this method provides real-time data about the track condition every time a train passes. Therefore, it can detect track defects early. In addition to being cost-effective instrumentation, this method could be fitted to all trains, eliminating expensive track measurement vehicles.

The majority of civil assets in the United States are still monitored by visual inspection, while continuous monitoring has become cost-effective in the manufacturing and aerospace fields. An aspect of some embodiments of this present disclosure is to detect railway track stiffness loss by using dynamic responses collected from in-service trains. The main hypothesis is that vertical acceleration can be used to infer track stiffness change. Due to the frequent passing of passenger trains over track sections, faults can be detected earlier than with dedicated inspection vehicles, and data-driven approaches can be statistically viable. Most traditional damage detection methods require comparing the dynamic properties of the damaged structure with those of its intact state, which may not always be possible in practice. An aspect of this disclosure is to build a broader detection system that defines anomalies as changes in behavior from a historical baseline. Using this historical detection technique, an entire network can be monitored without manually flagging problematic areas.

The presently disclosed subject matter offers a cost-effective, scalable, and continuous real-time solution for track stiffness monitoring using in-service rail vehicles, eliminating the need for expensive track recording vehicles (TRVs), track-side sensors, or manual inspections. By leveraging existing onboard sensors and edge computing, it provides frequent, real-time assessments at a fraction of the cost, without additional infrastructure, reducing capital and operational costs while improving safety and maintenance efficiency. Unlike traditional methods that struggle with varying train speeds, environmental noise, and optical sensor limitations, this system employs speed-independent analysis, wavelet coherence-based feature extraction, and multi-sensor joint detection, ensuring highly accurate defect identification with minimal false positives. By enabling predictive maintenance, it allows for early detection of track issues, preventing costly emergency repairs and minimizing service disruptions. Its simple integration process and ability to function without interfering with normal train operations make it a practical and scalable solution that can also be applied to other railway infrastructure components, such as bridges. Ultimately, this innovation enhances railway safety, extends track lifespan, increases operational efficiency, and reduces maintenance costs, making it a highly valuable tool for railway operators and infrastructure managers.

### SUMMARY OF THE PRESENTLY DISCLOSED SUBJECT MATTER

The disclosure deals with a system and method for railway track condition monitoring. Further, the disclosure deals with system and method for rapid detection of track changes from onboard data acquisition records, and encompassing areas of subject matter such as railroad tracks, stiffness, accelerometers, and monitoring.

The presently disclosed subject matter, broadly speaking, relates to civil engineering, and in particular relates to various matters potentially involved with railway track condition monitoring, track stiffness measurement, onboard vibration sensors, in-motion track inspection, predictive maintenance, edge computing in rail monitoring, railway infrastructure assessment, multi-sensor data fusion, and dynamic track stiffness evaluation.

The presently disclosed subject matter introduces an onboard, in-motion system that allows regular trains to monitor track conditions in real time as they operate. By analyzing vibrations and motion data from existing train sensors, the system can detect changes in track stiffness, which indicates potential weaknesses or maintenance needs. Unlike traditional inspections that require specialized vehicles or manual checks, this technology transforms everyday railcars into continuous monitoring tools, improving safety, efficiency, and maintenance planning. Its ability to quickly identify problem areas helps prevent costly failures and enhances railway reliability, making it a smart, scalable solution for modern rail networks.

The presently disclosed subject matter is for an in-motion track-condition-monitoring system designed for easy installation on in-service rail vehicles. It enables continuous detection of track stiffness changes using acceleration data from existing onboard sensors. Its core is a novel feature extraction, identification, and classification algorithm that is based on a hybrid signal processing technique within a multi-resolution analysis framework. It efficiently evaluates track strength in real time without requiring additional instrumentation. By leveraging edge computing, the system significantly reduces data transmission and storage demands, ensuring that only track-strength-relevant information is communicated. Unlike traditional methods that rely on visual inspections or dedicated monitoring vehicles, this solution transforms operational trains into frequent, cost-effective track inspectors, improving railroad safety, predictive maintenance, and network-wide risk assessment. Its high-frequency data collection enhances statistical confidence in track condition evaluations, allowing for early fault detection and rapid response to potential failures. Additionally, this approach is adaptable to other railway infrastructure elements, including bridges, making it a scalable, cost-effective solution for comprehensive rail asset monitoring.

Track stiffness is a critical parameter influencing infrastructure integrity, safety, and maintenance efficiency. Track stiffness variations over time and space lead to uneven load distribution, track degradation, and increased risk of failure, necessitating continuous monitoring and timely intervention. Current technologies determine stiffness under loaded or unloaded conditions at discrete locations, or through continuous measurements. They are either costly, labor-intensive, or limited in spatial and/or temporal resolution. Our innovation addresses the limitations and inefficiencies of traditional railway track monitoring methods by introducing a cost-effective, real-time, and scalable onboard track stiffness assessment system.

Currently, track condition monitoring relies on track-side sensors and dedicated track recording vehicles (TRVs), both of which have significant drawbacks. Track-side systems provide localized monitoring at fixed points, missing broader track degradation, while TRVs are expensive, require specialized optical and acceleration sensors, and operate only during off-duty hours, delaying critical inspections. Additionally, traditional standstill track stiffness measurement techniques such as jack-loading, impact hammer, and falling weight deflectometer (FWD) methods are slow, inefficient, and unsuitable for large-scale continuous monitoring.

The presently disclosed system solves these challenges by leveraging in-service rail vehicles for continuous track stiffness evaluation, transforming operational trains into real-time monitoring tools. Unlike visual inspections or optical-based TRVs, this system employs vibration-based sensing techniques, which are less sensitive to harsh environmental conditions and capable of detecting hidden substructure defects that conventional optical systems cannot identify. The innovation introduces a robust speed-independent assessment method, ensuring accurate detection of track issues at varying train speeds, and integrates edge computing with onboard data compression, significantly reducing storage and transmission costs by preserving only track stiffness-relevant data.

Additionally, it employs advanced signal processing techniques to minimize false positives, enhance sensitivity to weak oscillations, and improve defect localization. By leveraging joint detection across multiple sensors, the system enhances track condition assessment accuracy, even in noisy operational environments. This method also overcomes position uncertainty, ensuring high precision in identifying critical track weaknesses. Moreover, the system supports predictive maintenance by enabling frequent inspections throughout the day, rather than relying on infrequent TRV-based assessments. By proactively detecting subsurface track stiffness variations, which often precede visible track geometry defects, the system allows for early intervention, reducing maintenance costs, preventing infrastructure failures, and improving overall railway safety. Its scalability extends beyond tracks to other railway infrastructure elements, such as bridges, offering a versatile and comprehensive rail asset monitoring solution.

Track stiffness fluctuations serve as early indicators of potential infrastructure issues, posing risks to both passenger safety and service reliability. This subject matter aims to detect track stiffness variations by using dynamic responses obtained from in-service trains. A presently disclosed hybrid signal processing algorithm detects stiffness changes from vertical acceleration records obtained from onboard sensors. The disclosed system shows enhanced sensitivity to measurements, is resilient to noise, and has defect localization capabilities, for comprehensive evaluation of track stiffness changes across various timeframes and frequency ranges. Dynamic response analysis, particularly through the HWHT method, provides improved railway track stiffness monitoring. Leveraging real-time data from in-service trains and advanced signal processing techniques enables timely detection of stiffness variations, to augment operational safety and efficiency within railway systems.

The expansion of the United States railway network emphasizes the critical need for ongoing track stiffness monitoring to maintain safety and operational effectiveness. Track stiffness fluctuations serve as early indicators of potential infrastructure issues, posing risks to both passenger safety and service reliability. However, traditional monitoring methods like visual inspection and ultrasonic testing fall short in delivering consistent and comprehensive network-wide monitoring, underscoring the demand for robust track stiffness monitoring systems.

An aspect of some embodiments of this disclosure is to detect track stiffness variations by using dynamic responses obtained from operational trains. It discloses that vertical acceleration measurements can efficiently pinpoint stiffness changes, offering faster fault detection than conventional inspection methods. Another aspect of some embodiments of this disclosure is to establish a comprehensive detection system capable of identifying anomalies based on deviations from historical performance, thereby enabling network-wide monitoring without the need for manual identification of problematic areas. By introducing the Hybrid Wavelet-Hilbert Transform (HWHT) method, the present disclosure integrates Wavelet Packet Analysis (WPA) and the Hilbert-Huang Transform (HHT) to enhance sensitivity, noise resilience, and defect localization capabilities. This integrated approach facilitates a comprehensive evaluation of track stiffness changes across various timeframes and frequency ranges. Dynamic response analysis, particularly through the HWHT method, presents a promising avenue for advancing railway track stiffness monitoring. Leveraging real-time data from in-service trains and advanced signal processing techniques, this method enables timely detection of stiffness variations, thereby augmenting operational safety and efficiency within railway systems.

The anticipated market size for this disclosed subject matter is substantial. According to a report by Dataintelo, a market research and consulting firm headquartered in Ontario, California, the global rail condition monitoring market was valued at approximately USD 1.5 billion in 2023 and is projected to reach USD 3.9 billion by 2032, growing at a compound annual growth rate (CAGR) of 11.3% during this period. Similarly, the railway sensors market, which plays a crucial role in condition monitoring, is estimated to reach USD 2 billion by 2030, with a CAGR of 7.8% from 2023 to 2030. Rail Asset Management Market: Valued at $10.1 billion in 2021, it is projected to reach $13.2 billion by 2026, with a CAGR of 5.6%. Railway Telematics Market: Estimated at $5.1 billion in 2021, expected to grow to $7.3 billion by 2026, at a CAGR of 7.5%. Railway Management System Market: Valued at $37.98 billion in 2024, anticipated to reach $144.90 billion by 2034, expanding at a CAGR of 12.94%. Machine Condition Monitoring Market: Estimated at $3.49 billion in 2024, projected to grow at a CAGR of 7.6% from 2025 to 2030. These figures indicate a robust and expanding market, suggesting substantial opportunities for technologies that enhance rail infrastructure monitoring and maintenance.

In one exemplary embodiment disclosed herewith, a system and method for railway track condition monitoring is described.

It is to be understood that the presently disclosed subject matter equally relates to associated and/or corresponding methodologies. One exemplary such method relates to a method for railway track condition monitoring of a rail system, comprising collecting field data while a railcar is in motion along a track in a rail system using at least one accelerometer attached to at least one railcar axle box of the railcar while synchronously recording associated GPS information of the railcar; and processing the collected field data for dynamic response analysis using hybrid signal processing for detecting track stiffness changes in the rail system.

For some such exemplary embodiments, the method may further comprise further comprising identifying and classifying track stiffness changes based on the dynamic response analysis.

Other example aspects of the present disclosure are directed to systems, apparatus, tangible, non-transitory computer-readable media, user interfaces, memory devices, and electronic devices for railway track condition monitoring. To implement methodology and technology herewith, one or more processors may be provided, programmed to perform the steps and functions as called for by the presently disclosed subject matter, as will be understood by those of ordinary skill in the art.

Another exemplary embodiment of presently disclosed subject matter relates to a detection system for the identification of Rail Surface Spot Irregularities (RSSI) of a rail system, comprising at least one accelerometer attached to at least one railcar axle box of a railcar for collecting Axle Box Acceleration (ABA) field data obtained from the at least one railcar axle box while the associated railcar is in motion along a track in a rail system; and one or more processors programmed. Such one or more processors are preferably programmed for synchronously recording associated railcar GPS information, and processing the collected ABA field data for dynamic response analysis using hybrid signal processing for detecting track stiffness changes in the rail system.

For some such exemplary embodiments, the one or more processors may further be programmed for identifying and classifying track stiffness changes based on the dynamic response analysis.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures, in which:

FIGS. 1(A), 1(B), and 1(C), illustrate three respective modules of the presently disclosed technology, including FIG. 1(A) illustrating data acquisition module, FIG. 1(B) illustrating a feature identification algorithm for lateral stiffness change detection implemented on an edge computing platform, and FIG. 1(C) illustrating classification based on track strength assessment, encompassing the identification of defect locations, severity levels, and affected track elements;

FIG. 2 illustrates images representing successful verification in the field for rail surface defect detection in accordance with presently disclosed subject matter;

FIG. 3 schematically illustrates an auxiliary mass system positioned over a track for data collection;

FIG. 4(A) graphically illustrates simulator input and output for track stiffness change;

FIG. 4(B) graphically illustrates simulator input and output for Auxiliary-Based Analysis (ABA) record;

FIG. 5(A) graphically illustrates Wavelet Packet (WP) coefficients for Wavelet Packet Analysis (WPA) output;

FIG. 5(B) graphically illustrates Wavelet Packet (WP) coefficients for subset reconstruction;

FIG. 6(A) graphically illustrates Analytical signal magnitude of Hilbert-Huang Transform (HHT) output;

FIG. 6(B) graphically illustrates IMF1 Fourier spectrum of Hilbert-Huang Transform (HHT) output;

FIG. 7(A) graphically illustrates the Hilbert spectrum of Hilbert instantaneous energy;

FIG. 7(B) graphically illustrates instantaneous energy of Hilbert instantaneous energy;

FIGS. 8(A), 8(B), and 8(C), graphically illustrates three respective different predefined track stiffness ratings or changes versus normalized distances;

FIGS. 8(D)-8(F) respectively graphically illustrate Hilbert spectrum data relative to the presently disclosed algorithm's response and sensitivity to various types of track stiffness changes in FIGS. 8(A), 8(B), and 8(C), and

FIGS. 8(G)-8(I) respectively graphically illustrates instantaneous energy data relative to a detailed comparison between the detected stiffness changes and the actual trends introduced in the simulation, which illustrates the presently disclosed algorithm's precision in tracking stiffness variations according to track stiffness changes in FIGS. 8(A), 8(B), and 8(C).

Repeat use of reference characters in the present specification and drawings is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

As used herein, the term “or” is inclusive unless stated otherwise. For instance, if a computer requires A or B to be true in order to perform operation C, the case of both A and B being true will satisfy the condition necessary for C to occur. That is, “or” is inclusive of A, B, and A and B.

In general, the present disclosure is directed to systems and methodology which functions to detect track stiffness variations by using dynamic responses obtained from in-service trains. A presently disclosed hybrid signal processing algorithm detects stiffness changes from vertical acceleration records obtained from onboard sensors. The disclosed system shows enhanced sensitivity to measurements, is resilient to noise, and has defect localization capabilities, for comprehensive evaluation of track stiffness changes across various timeframes and frequency ranges. Dynamic response analysis, particularly through the HWHT method, provides improved railway track stiffness monitoring. Leveraging real-time data from in-service trains and advanced signal processing techniques enables timely detection of stiffness variations, to augment operational safety and efficiency within railway systems.

The presently disclosed subject matter relates to developing and qualifying a prototype on-board system for track stiffness change detection in the vertical and lateral directions that provides a proxy measurement of track lateral strength from an in-motion system. The presently disclosed method detects stiffness changes from acceleration records collected from data acquisition systems installed on rail vehicles, while the vehicles travel at normal operating speeds along the track. At the core of the presently disclosed system is a novel and efficient feature extraction, identification and classification algorithm developed for in-motion track evaluation and characterization. The method is based on a hybrid signal processing technique implemented within a fast multi-resolution analysis framework. Feasibility, proof-of-concept and preliminary validation reviews have been completed through field measurements and computer simulations [1-3] . We will leverage the success and findings of our previous and current subject matter to develop, test, and qualify a prototype in-motion system (software and hardware), that implements the track health monitoring and classification algorithm to the track lateral strength assessment.

It is emphasized that the presently disclosed technology does not require any additional, or new, instrumentation; it simply makes better use of existing data that is already being collected by conventional instrumentation. Furthermore, edge computing implementation yields significant data reduction since only track strength pertinent information (location, track element, and severity) is communicated to the server. This ensures minimal data transfer and storage needs, even when applied to extensive rail networks.

The presently disclosed in-motion system provides continuous assessment of track lateral resistance under dynamic conditions and will significantly improve railroad safety by effectively detecting critical track locations prone to track buckles. It is suitable for potential installation on every rail car and, can be implemented as a standalone warning system, as well as be a part of a comprehensive network-wide monitoring tool when integrated with other track assessment technologies for track buckling risk assessment and predictive maintenance. It aligns, thus, with FRA’s strategic priorities and needs and is consistent with BAA topic FRA-TR-007: Research and Development on Track Lateral Strength, (a) Develop a technology to provide a proxy measurement of track lateral strength from an in-motion system.

With nearly 140,000 miles of track, railroad roughly covers 42% of all the revenue freight in terms of ton-miles in North America. Each day, railroad carries approximately one-third of U.S. exports, and delivers five million tons of freight and approximately 85,000 passengers (Amtrak only). Maintaining the railroad infrastructure in a state of good repair to prevent failure and service disruptions is a challenge of paramount importance to the safety and economy of operations.

Track stiffness change can be viewed as a track performance indicator that identifies track issues associated with common types of damage in railway networks that affect track operating conditions [21-25]. Such stiffness changes along the track arise typically from deteriorating components such as damaged ties, and poor ballast condition, among others, and grow as load accumulates [26, 27]. Furthermore, changes of track lateral stiffness along the track lead to nonuniform track lateral dynamic resistance which is critical in preventing track buckling in view of fluctuations of the rail neutral temperature and it needs to be sustained above a threshold value.

Current research activities on buckling risk assessment focus primarily on static buckling analysis where the effects of dynamic train loads are simplified or ignored [28, 29]. Buckling assessment procedures typically consider the influence of track parameters (e.g., ballast fouling level or frictional tie) on the static track lateral resistance in combination with longitudinal loads, while typically ignoring vertical loading . In reality, buckling events occur most frequently due to the combined effects of the track dynamic lateral stiffness and the dynamic vehicle loads which cause track uplift effectively reducing lateral resistance . A track that may qualify as sufficient under static loading conditions may fail under dynamic loading conditions. These important nuances regarding track lateral stiffness under dynamic loading are absent in current understanding. To address this knowledge gap, the presently disclosed subject matter evaluates the track lateral dynamic stiffness as a proxy of lateral resistance under service loading. This information of track lateral strength under dynamic loading will contribute to general buckling prediction models. Further, this method of analyzing on-board measurements would provide significantly increased resolution relative to current typical practice of Single Tie Push Test (STPT).

The presently disclosed technology is an automated system designed for comprehensive track strength assessment in the lateral vertical and longitudinal directions. It combines acceleration sensors, edge computing, and digital communication into a single, low-cost, high-speed, and accurate system, enabling continuous and detailed track health monitoring at operational train speeds. At the core of the presently disclosed system is a novel, and efficient feature extraction, identification and classification algorithm for in-motion track evaluation and characterization. The system is tested and validated both in simulated environments and in the field for rail squat detection, identification and characterization . The algorithm has also been validated in a high fidelity simulated environment for vertical and track lateral strength change detection and characterization [16, 31-33]. It is therefore considered at Technology Readiness Level (TRL) 5. Further development of the system for assessing track lateral dynamic resistance encompasses the development of a first-generation prototype (hardware and software) which will be evaluated, demonstrated and qualified, through simulations, high fidelity lab testing, and field implementation and testing in collaboration with our industry partner. The team has prior experience and expertise in software development edge computing, AI, experimental mechanics, and advanced modeling and simulations. Upon completion of Phase I the technology will be at TRL 6 and completion of Phase II will raise the TRL to 7.

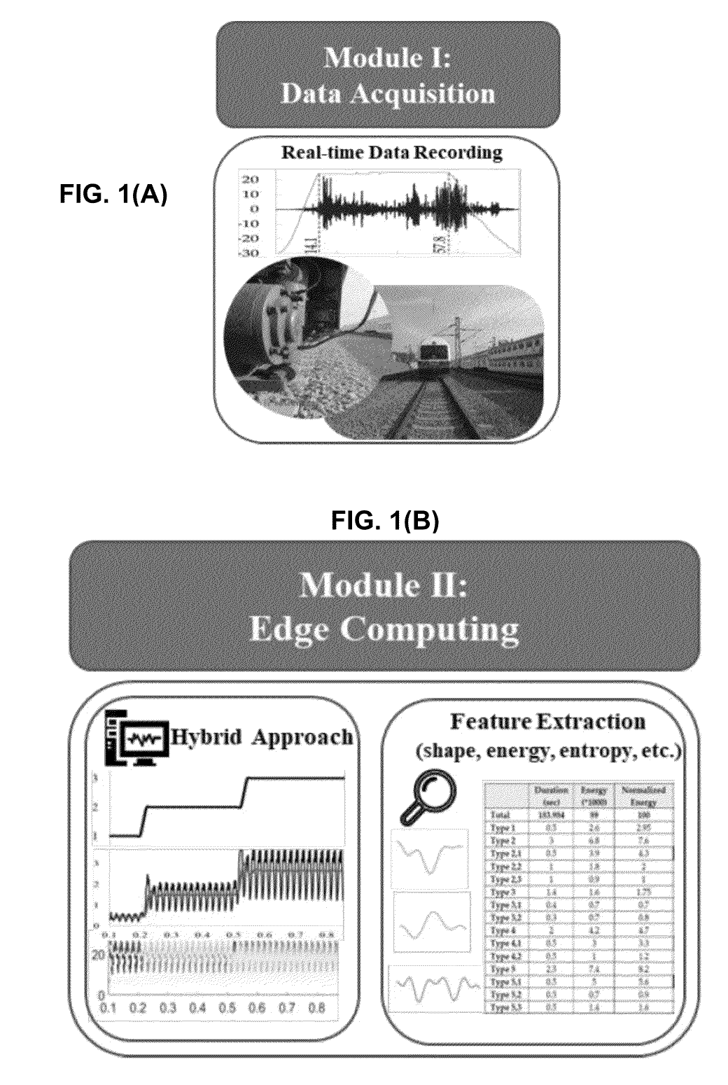

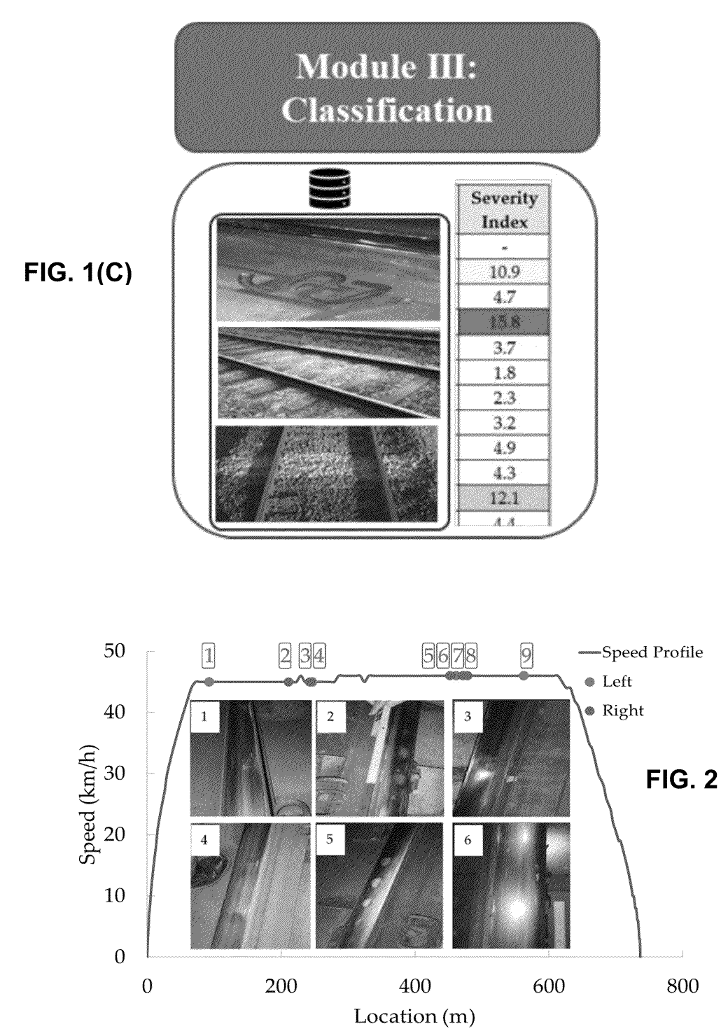

The presently disclosed system will be developed based on three key modules, shown in FIGS. 1(A), 1(B), and 1(C), which include FIG. 1(A) illustrating data acquisition module, FIG. 1(B) illustrating a feature identification algorithm for lateral stiffness change detection implemented on an edge computing platform, and FIG. 1(C) illustrating classification based on track strength assessment, encompassing the identification of defect locations, severity levels, and affected track elements.

More specifically, FIG. 1(A) (Module I) comprises accelerometer sensors for railcar installation, GPS sensor, and the data acquisition hardware for communication with the edge computing platform.

FIG. 1(B) (Module II) integrates the strengths of Wavelet Packet Analysis (WPA), Empirical Mode Decomposition (EMD), and the Hilbert Transform (HT) to develop a robust track strength assessment framework. WPA is employed for its ability to analyze non-stationary signals across multiple frequency bands, providing detailed time-frequency resolution critical for identifying localized events by providing high resolution. EMD further refines the reconstructed signal by decomposing it into a finite number of Intrinsic Mode Functions (IMFs), which are oscillatory components with localized time-frequency properties. Finally, HT is applied to the modes derived from EMD to calculate instantaneous frequency and amplitude, enabling precise localization and characterization of the track strength features within the signal. Tremendous data compression (over 96%) is achieved at this stage since only track strength information is communicated with Module III – track strength evaluation and characterization and stored on the server. This presently disclosed workflow exhibits superior performance over other methods for non-stationary signal analysis since it utilizes an adaptive window size to examine track strength along the length of the recorded signal [34, 35].Essentially, this involves selecting a mother wavelet to create a family of test functions, and then the similarity is controlled by scaling (dilations) and shifting (translations) of a set of multidimensional windows.

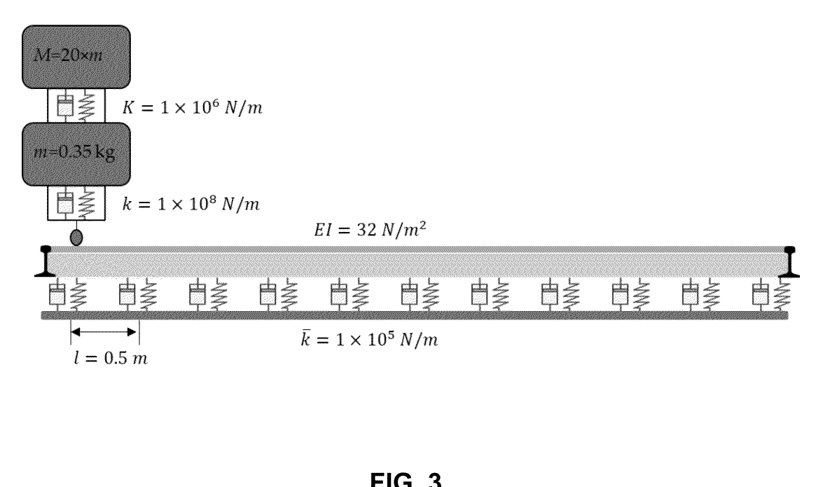

FIG. 1(C) illustrates Module III, which focuses on change classification based on track strength assessment, encompassing the identification of stiffness change locations, severity levels, and affected track elements through data driven models. Using the processed data from Module II, this module applies advanced classification algorithms to systematically categorize track conditions. It evaluates the spatial and/or temporal characteristics of track defects, enabling precise mapping of issues along the track network. By integrating machine learning techniques, the module ensures that the classification process remains adaptive to varying operational conditions and defect types. This classification outcome provides actionable insights, allowing for targeted maintenance strategies, and supports network-wide monitoring efforts by storing classified data and visualizing defect patterns in a user-friendly interface for railway operators. The classification module is the final step in delivering comprehensive track health analytics and directly supports predictive maintenance and operational safety initiatives. The track strength assessment algorithm has been successfully tested with simulated and field data, as shown in FIG. 3 for the rail squat detection application [1]. In other words, FIG. 3 schematically illustrates an auxiliary mass system positioned over a track for data collection.

The presently disclosed subject matter will be completed in two phases. Phase I pertains to the prototype development and testing and Phase II focuses on field implementation and testing. Part of the implementation of the presently disclosed subject matter commences with the design specifications of the first-generation prototype of the presently disclosed system comprising the selection of the sensors and mounting hardware, the computing platform, and power and storage management. In parallel, the development of the software associated with Module II will commence optimizing the track stiffness change detection algorithm for edge computing focusing on real time processing, minimization of data loss while maintaining accuracy and efficiency. This module will implement the existing algorithms for the hybrid signal processing technique and signal feature extraction in a self-contained program with communication capabilities and user-friendly app. The deployment of a detailed 1:7 scale train-track setup for laboratory testing is currently in progress. This is a unique testing setup that accommodates, in a modular form, detailed physical models of various moving vehicles, and a physical model of a track structure with adjustable parameters and components and will be used in high fidelity laboratory testing of the presently disclosed system during Phase I. Module II software will be tested first offline using simulated data, data collected from the testing setup and data provided by the industry sponsor. At this time the development and implementation of a robust classification system to analyze track strength and detect anomalies will commence. Building on the outputs from the detailed small-scale train-track laboratory setup along with the Rapid-3DVTI simulator developed for a previous FRA project, the classification system will leverage machine learning algorithms and advanced data processing techniques to identify, categorize, and quantify track stiffness changes. Subsequently, the three modules will be integrated into the prototype system and tested in the laboratory and the field. Our industry partners are committed to collecting and sharing supplemental data as specified by the project needs and to providing insight into the quality of data, and data interpretation. The data needed to perform the presently disclosed subject matter is already familiar. Furthermore, simulated measurements will be generated by the Rapid-3DVTI simulation tool where track changes will be simulated.

We have developed the analysis tool and lab test needed for implementation. The presently disclosed scope of work consists of six high level tasks to be conducted in two phases. The details of each individual module and their associated tasks are presented below:

Phase 1 – Prototype Development and Testing

Task 1. Track Strength Assessment Algorithm: The objective of this task is to optimize the track stiffness change detection algorithm for edge computing focusing on real time processing, minimization of data loss while maintaining accuracy and efficiency. This module will implement the existing algorithms for the hybrid signal processing technique and signal feature extraction in a self-contained program with a user-friendly graphical user interface. This module will be tested and verified with (i) field records, (ii) laboratory test results and (iii) simulated data.

Task 2. Track Strength Classification System: This task focuses on developing and implementing a robust classification system to analyze track strength and detect anomalies. Building on the outputs from the detailed small-scale train-track laboratory setup along with the Rapid-3DVTI simulator developed for a previous FRA project, the classification system will leverage machine learning algorithms and advanced data processing techniques to identify, categorize, and quantify defects. Key objectives include evaluating track conditions by analyzing vibration and acceleration data, determining the severity and location of stiffness changes. The classification system will integrate seamlessly with the data acquisition and processing modules, ensuring a continuous flow of actionable insights for railway operators. Moreover, we will work with our industry sponsors and FRA to define different threshold values associated with different service criteria and risk management, which can be integrated to existing track safety standards or track quality indices [36-38]. The system will include a user-friendly interface for visualizing classified data and report generation, enabling informed decision-making for maintenance planning and resource allocation.

Task 3. Offline Implementation and Validation: This task will take the presently disclosed hybrid signal processing method (Module II) and the track strength classification system (Module III) and implement the detection method offline using field measurements provided by CSX and/or FRA, lab test signals using the small-scale train-track setup and artificial records generated by the Rapid-3DVTI simulator. The software will be developed to take input acceleration time history and output the track strength classification, change severity index, and location. The storage needs of the method will be determined here, including how to efficiently store the classification and location. In addition, the data acquisition parameters and needs will be determined, e.g. length of track to analyze in a single data packet, speed of train, etc.

Task 4. First Generation Prototype Development: The objective of this task is to develop the first-generation prototype system by integrating data acquisition (Module I) with Modules II and III for processing in real time. First, the prototype will be assembled. This could include the edge computing module, the classification database and classification server and storage, as well as the accelerometer itself, consistent with industry standards. These will be installed on a manual rail cart that will be tested on the indoor track testing laboratory at USC. This task will determine the required data acquisition sampling rates and optimal sensor placement in relation to the rails and wheels.

Phase 2 – Field Implementation and Qualification

Task 5. Field Implementation and Demonstration: In this module, the prototype will be brought to the field and extensive testing will be conducted for performance assessment and to identify areas of system improvement and optimization in terms of computation power, storage requirements, sampling rate and sensor placement. Output results from the presently disclosed hybrid technique will be compared with inspection results using current industry standard techniques.

Task 6. Field Qualification: Working with industry partners, the prototype will be implemented on active rail traffic. The generated databases of track strength classification and location can be cross checked with current industry inspection techniques. The production of multiple packages and distribution to as many rail networks as available will provide adequate field demonstration and qualification of the technology.

### METHODS

### Hybrid Wavelet-Hilbert transform (HWHT)

This method leverages the complementary strengths of Wavelet Packet Analysis (WPA), which excels in decomposing signals into different frequency components, and the Hilbert-Huang Transform (HHT), which specializes in analyzing nonlinear and non-stationary signals. By integrating these two techniques, the hybrid method offers several advantages, including enhanced sensitivity to stiffness variations, robustness to noise, and accurate localization of defects. Furthermore, the multi-scale analysis capabilities of wavelet packet analysis and the adaptability of HHT enable the hybrid method to provide a comprehensive assessment of track stiffness changes across different time scales and frequency bands. In this present disclosure, we present an overview of the hybrid method for track stiffness change detection, discussing its underlying principles, advantages, and potential applications in railway maintenance and safety. We also review recent developments and case reviews showcasing the effectiveness of this method in real-world railway environments. Through this exploration, we aim to highlight the significance of the hybrid method as a valuable tool for enhancing railway infrastructure monitoring and maintenance, ultimately contributing to the safety and reliability of railway transportation systems.

### Numerical model

In this present disclosure, we developed a comprehensive numerical model using a 2-degree-of-freedom (2-DOF) auxiliary mass system to simulate onboard track stiffness change detection. This model incorporates a spring-dashpot system to represent the Hertzian contact between the wheel and rail, with the contact point precisely mapped based on our previous reviews. Additionally, a secondary spring-dashpot connection simulates the primary suspension system, which is crucial for capturing high-frequency interactions between the wheel and rail. The top mass in this configuration represents the combined mass of the bogie and car body, allowing the model to maintain computational efficiency while accurately reflecting real-world dynamics.

FIG. 3 illustrates schematically what may be regarded as an auxiliary mass system positioned over a track for the purposes of data collection. The rail track may be modeled, such as a Timoshenko beam, which accounts for shear deformation and rotational bending effects, providing a detailed and realistic representation of the rail's behavior. To simulate the support conditions of the rail track, we use a beam over multiple layers of distributed spring-damper elements, as represented in FIG. 3. The stiffness of these spring elements is dynamically adjusted to reflect varying track conditions, such as loose fasteners or damaged ballast. For instance, the stiffness is reduced if a fastener is loose or ballast is compromised and is considered zero if a fastener is missing, or the sleeper is unsupported due to poor ballast condition. This approach enables the model to respond accurately to real-time changes in track conditions.

The distributed spring-damper elements are placed at intervals corresponding to the sleeper spacing, which is critical for accurately representing the track's support conditions. This configuration allows for a detailed evaluation of the track's structural integrity under different scenarios. The primary goal of this model is to assess the feasibility and effectiveness of Auxiliary-Based Analysis (ABA) in detecting real-time changes in track stiffness. By simplifying the complex interactions between the wheel and rail into a manageable computational model, we ensure cost-effectiveness while maintaining the necessary accuracy to identify critical changes in track conditions.

This numerical model serves as a robust tool for predicting rail track performance and identifying potential issues such as loose fasteners, damaged ballast, or unsupported sleepers.

### RESULTS

### Detailed steps for a simple case

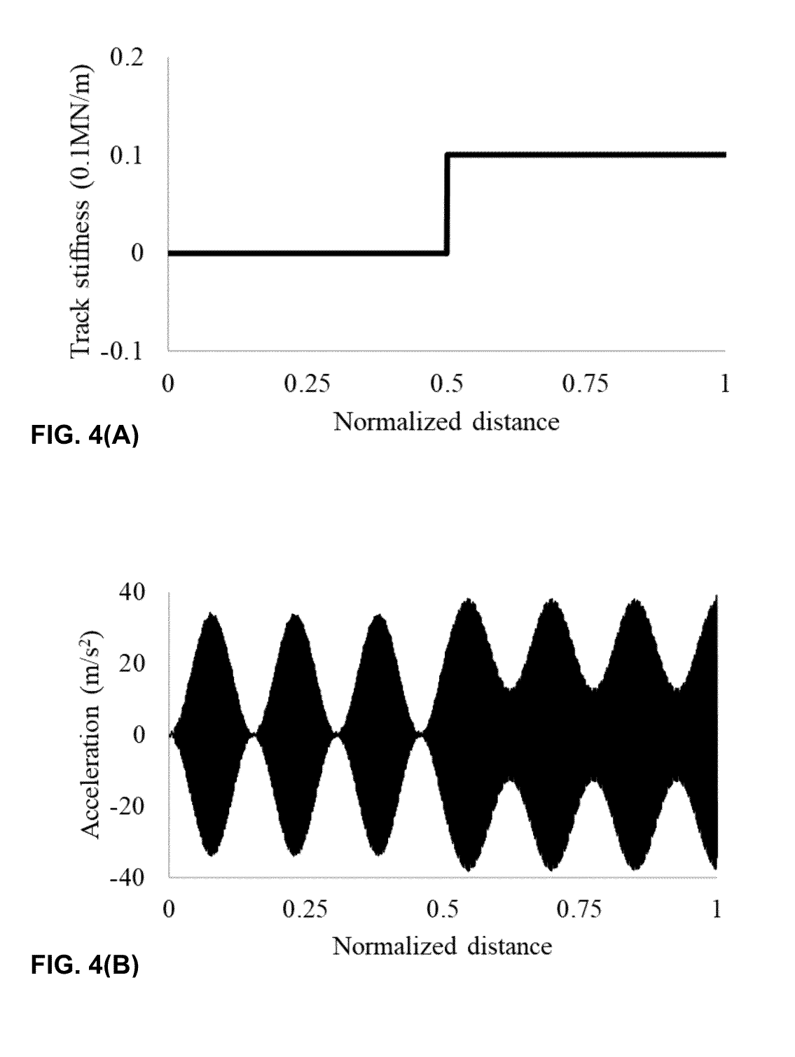

In this present disclosure, track stiffness change is represented by a step function with a pronounced jump in the middle of the track, as illustrated in FIG. 3. The dynamic response of the auxiliary mass system is evaluated over the entire track length, and the Auxiliary-Based Analysis (ABA) record is shown in FIGS. 4(A) and 4(B). More specifically, FIG. 4(A) graphically illustrates simulator input and output for track stiffness change, while FIG. 4(B) graphically illustrates simulator input and output for Auxiliary-Based Analysis (ABA) record. The dynamic system evaluation employs a 5-millisecond time step, resulting in a sampling frequency of 200 Hz. This frequency selection allows us to analyze the ABA record for frequencies below 100 Hz, with a specific focus on identifying changes within the low-frequency range, particularly those less than 25 Hz.

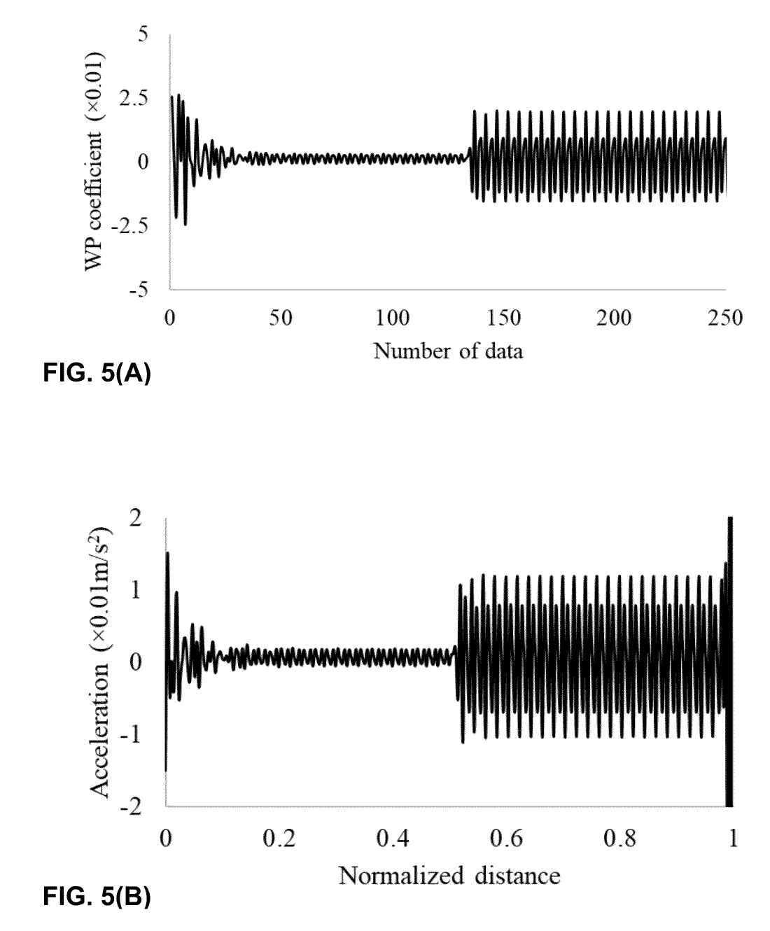

To achieve this, the ABA record is decomposed into four subsets, each covering specific frequency bands up to 100 Hz. The subset representing frequencies from 0 to 25 Hz is selected for further analysis. The corresponding Wavelet Packet (WP) coefficients and the subset are depicted in FIGS. 5(A) and 5(B). More specifically, FIG. 5(A) graphically illustrates Wavelet Packet (WP) coefficients for Wavelet Packet Analysis (WPA) output, while FIG. 5(B) graphically illustrates Wavelet Packet (WP) coefficients for subset reconstruction. This selected subset is then processed using the Hilbert-Huang Transform (HHT) algorithm to evaluate the complex signal and its corresponding instantaneous energy.

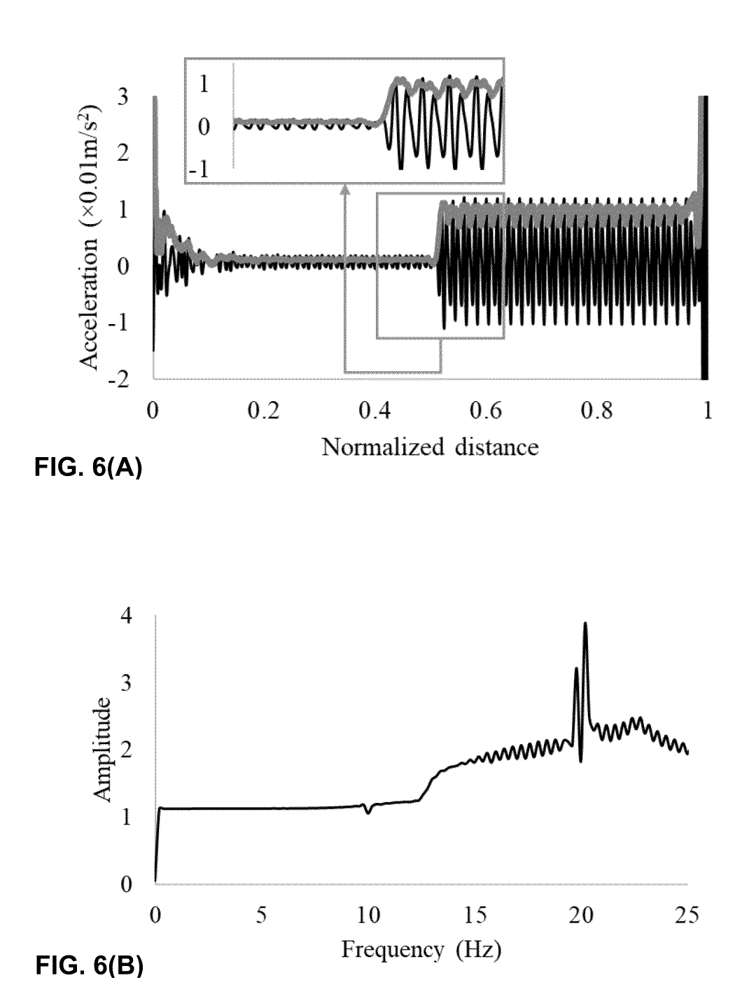

FIG. 6(A) graphically illustrates the magnitude of the analytical signal using the Hilbert-Huang Transform (HHT) output. Notably, the zoomed-in inset section reveals a distinct shift at the midpoint of the path, indicating the distribution of track stiffness change introduced in this section. The frequency component of the signal, presented in FIG. 6(B), shows that the predominant frequency is 20 Hz. More specifically, FIG. 6(B) graphically illustrates the IMF1 Fourier spectrum of the Hilbert-Huang Transform (HHT) output.

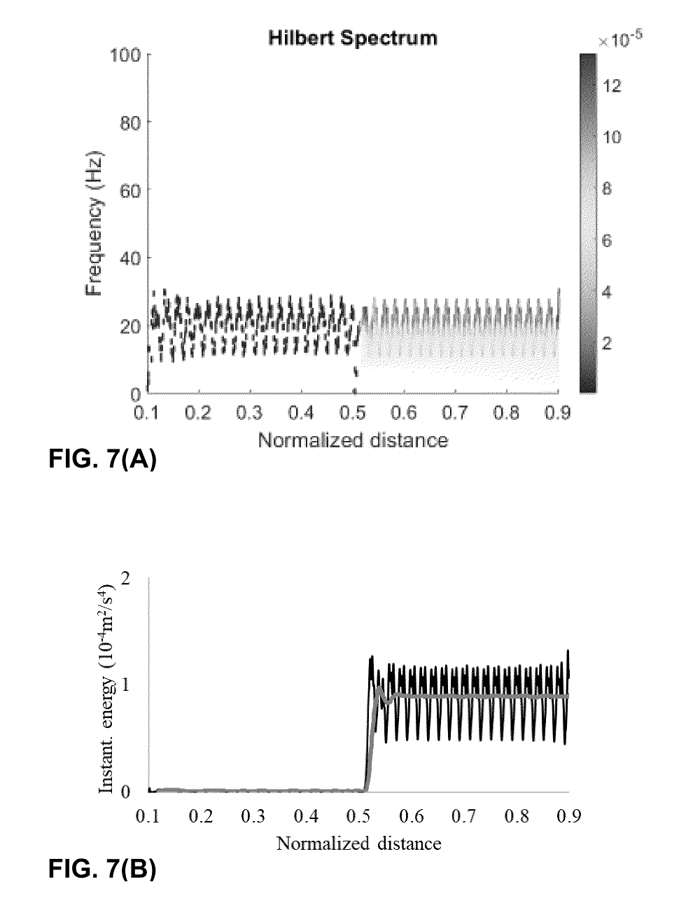

The Hilbert spectrum, displayed in FIG. 7(A), evaluates the instantaneous energy of the analytical signal within a time-frequency framework. More specifically, FIG. 7(A) graphically illustrates the Hilbert spectrum of the Hilbert instantaneous energy. The spectrum indicates that the energy fluctuation around the 20 Hz frequency, noted earlier, begins at the midpoint and continues to the end of the track. This fluctuation behavior remains consistent throughout. Additionally, the instantaneous energy of the analytical signal is found to be negligible. FIG. 7(B) graphically illustrates the instantaneous energy amplitude, where the red graph (single centralized graph line) represents the rolling average of instantaneous energy fluctuations.

There is a strong correlation between this graph and the introduced stiffness change graph, suggesting that with a known transfer function between instantaneous energy and track stiffness change, this method holds promise for onboard track stiffness change detection and measurement through ABA records.

To further validate the presently disclosed method, the present disclosure evaluates the approach for three additional cases of track stiffness change trends. These cases will help demonstrate the robustness and reliability of the presently disclosed system in various track conditions, reinforcing its potential for real-time track monitoring and maintenance applications.

### Evaluation of the presently disclosed method by introducing different cases

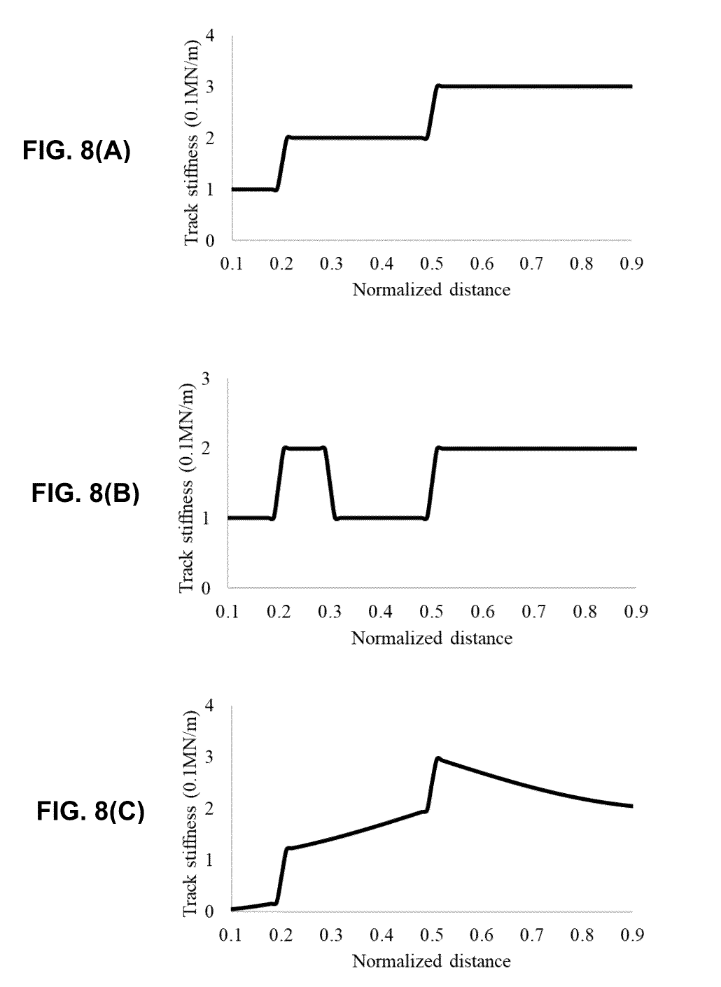

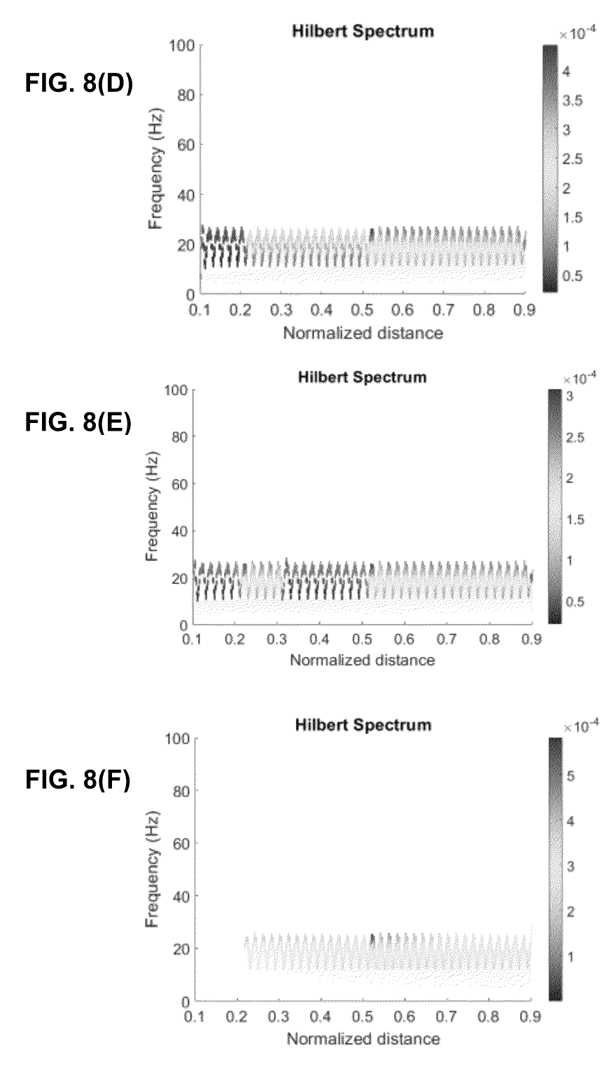

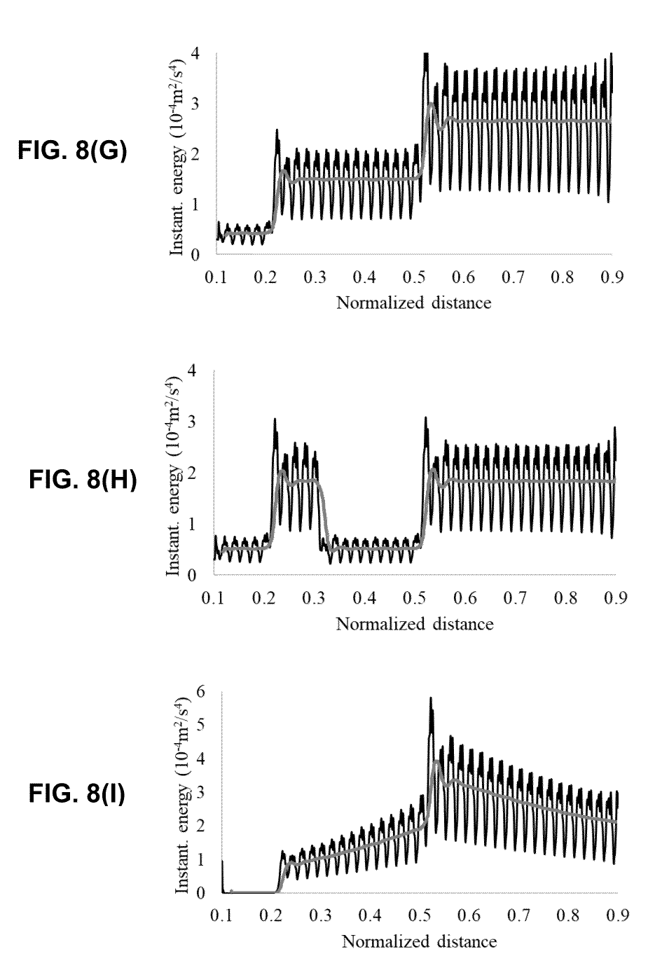

In this section, the effectiveness of the presently disclosed algorithm for detecting track stiffness changes is evaluated by introducing three distinct track stiffness change trends, as depicted in FIGS. 8(A)-8(C). In particular, FIGS. 8(A), 8(B), and 8(C), graphically illustrates three respective different track stiffness ratings versus normalized distances. The algorithm's performance is assessed by applying it to these three predefined stiffness change trends illustrated in FIGS. 8(A), 8(B), and 8(C). The results in respective FIGS. 8(D)-8(I) shown clearly demonstrate the algorithm's capability to accurately capture and identify the changes in track stiffness. For each trend, the dynamic response of the auxiliary mass system is analyzed, and the corresponding ABA records are processed to detect shifts in track stiffness.

Results represented in FIGS. 8(D)-8(F) correspond respectively with the three predefined stiffness change trends respectively illustrated in FIGS. 8(A), 8(B), and 8(C). Likewise, results represented in FIGS. 8(G)-8(I) correspond respectively with the three predefined stiffness change trends respectively illustrated in FIGS. 8(A), 8(B), and 8(C).

In FIGS. 8(D)-8(F), the algorithm's response to each respective trend in FIGS. 8(A), 8(B), and 8(C), is plotted, showcasing its sensitivity to various types of stiffness changes. In other words, FIGS. 8(D)-8(F) respectively graphically illustrate Hilbert spectrum data relative to the presently disclosed algorithm's response and sensitivity to various types of track stiffness changes in FIGS. 8(A), 8(B), and 8(C). The results indicate that the algorithm successfully identifies both abrupt and gradual changes in stiffness, validating its robustness across different scenarios.

Additionally, FIGS. 8(G)-8(I) respectively graphically illustrates instantaneous energy data relative to a detailed comparison between the detected stiffness changes and the actual trends introduced in the simulation, which illustrates the presently disclosed algorithm's precision in tracking stiffness variations according to track stiffness changes in FIGS. 8(A), 8(B), and 8(C). So such comparisons further illustrate the algorithm's precision in tracking stiffness variations, with a high degree of correlation between the detected changes and the predefined trends. The successful detection of these changes across multiple cases underscores the algorithm's reliability and accuracy.

### CONCLUSIONS

In this present disclosure, we developed and evaluated a numerical model for onboard track stiffness change detection using a 2-degree-of-freedom auxiliary mass system. The model simulates the dynamic interaction between the wheel and rail, incorporating key elements such as Hertzian contact, primary suspension dynamics, and track support conditions represented by distributed spring-damper elements. We employed the ABA method to monitor and analyze changes in track stiffness. The model was tested against various predefined track stiffness change trends to assess its effectiveness and accuracy in detecting these changes.:

By decomposing the ABA record into specific frequency bands and focusing on the 0-25 Hz range, the model successfully identifies changes in track stiffness. The Hilbert-Huang Transform (HHT) method enhances the analysis by providing detailed insights into the instantaneous energy and frequency components of the signal.

The algorithm demonstrated a high sensitivity to different track stiffness change trends, including abrupt, gradual, and periodic variations. The results consistently showed a strong correlation between detected changes and the actual predefined trends, validating the model's robustness.

The promising results suggest that the presently disclosed method can be a valuable tool for railway operators, contributing to safer and more efficient railway operations.

### FUTURE IMPLEMENTATION OF SUBJECT MATTER

Future implementation of presently disclosed subject matter will focus on further validating the method under different track conditions, evaluating change indices to classify different stiffness changes based on their severity, conducting noise robustness reviews, examining the effects of train speed on detection accuracy, and exploring the integration of this method into existing railway monitoring systems. An aspect of continued development is to refine the method and ensure its practical applicability in diverse and real-world railway environments.

The presently disclosed subject matter will produce a validated prototype system of a cost-effective technology for the automated detection, classification, and localization of track strength changes in all three directions from onboard vibration measurement sensors, including the Damage Severity Index (DSI) that shows the impact of the change on the system. Specific outcomes stemming from this project’s mission are centered around the need to improve the safety of track infrastructure and performance of track risk management including:

The presently disclosed in-motion system provides continuous assessment of track lateral resistance under dynamic conditions and will significantly improve railroad safety by effectively detecting critical track locations prone to track buckles.

It is suitable for potential installation on every rail car and can be implemented as a standalone warning system monitoring the severity of the detected change with respect to established thresholds.

It may be installed as a part of a comprehensive network-wide monitoring tool when integrated with other track assessment technologies for track buckling risk assessment and predictive maintenance.

The presently disclosed system can be installed on any railcar on the rail network, facilitating the frequent, networkwide assessment of track stiffness variations and track lateral resistance in real time and at normal operating speeds while minimizing data transfer and storage requirements.

The presently disclosed technology represents a low cost, high return investment highly suitable for rail industry adoption.

Some Abbreviations used in this disclosure may include:
2-DOF 2-Degree-of-Freedom
ABA Auxiliary-Based Analysis
GPR Ground Penetrating Radar
HHT Hilbert-Huang Transform
HWHT Hybrid Wavelet-Hilbert Transform
WP Wavelet Packet
WPA Wavelet Packet Analysis

This written description uses examples to disclose the presently disclosed subject matter, including the best mode, and also to enable any person skilled in the art to practice the presently disclosed subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural and/or step elements that do not differ from the literal language of the claims, or if they include equivalent structural and/or elements with insubstantial differences from the literal languages of the claims. In any event, while certain embodiments of the disclosed subject matter have been described using specific terms, such description is for illustrative purposes only, and it is to be understood that changes and variations may be made without departing from the spirit or scope of the subject matter. Also, for purposes of the present disclosure, the terms "a" or "an" entity or object refers to one or more of such entity or object. Accordingly, the terms "a", "an", "one or more," and "at least one" can be used interchangeably herein.

### REFERENCES

1. Naseri, R., et al. A Hybrid Rail Surface Spot Irregularities (Rssi) Detection Algorithm Based on Onboard Measurements. in ASME/IEEE Joint Rail Conference. 2024. American Society of Mechanical Engineers

2. Wang, L., Y. Zhang, and S.T. Lie, Detection of damaged supports under railway track based on frequency shift. Journal of Sound and Vibration, 2017. 392: p. 142-153, https://doi.org/10.1016/j.jsv.2016.11.018.

3. Naseri, R. and S. Mohammadzadeh, Nonlinear Train-Track-Bridge Interaction with Unsupported Sleeper Group. International Journal of Railway Research, 2020. 7(1): p. 11-28, https://doi.org/10.22068/IJRARE.7.1.11.

4. Naseri, R., S. Mohammadzadeh, and D.C. Rizos, Rail surface spot irregularity effects in vehicle-track interaction simulations of train-track-bridge interaction. Journal of Vibration and Control, 2024: p. 10775463241232024, 10.1177/10775463241232024.

5. Naseri, R., B.L. Gedney, and D.C. Rizos, Hybrid rail squat detection algorithm using axle box acceleration. To be submitted, 2024

6. Malekjafarian, A., et al., Railway track loss-of-stiffness detection using bogie filtered displacement data measured on a passing train. Infrastructures, 2021. 6(6): p. 93

7. Loveday, P.W., C.S. Long, and D.A. Ramatlo, Ultrasonic guided wave monitoring of an operational rail track. Structural Health Monitoring, 2020. 19(6): p. 1666-1684

8. Wang, S., et al., State-of-the-art review of ground penetrating radar (GPR) applications for railway ballast inspection. Sensors, 2022. 22(7): p. 2450

9. Pannese, E.M., et al., Bridge transition monitoring: Interpretation of track defects using digital image correlation and distributed fiber optic strain sensing. Proceedings of the Institution of Mechanical Engineers, Part F: Journal of Rail and Rapid Transit, 2020. 234(6): p. 616-637

10. Aied, H., A. González, and D. Cantero, Identification of sudden stiffness changes in the acceleration response of a bridge to moving loads using ensemble empirical mode decomposition. Mechanical Systems and Signal Processing, 2016. 66-67: p. 314-338, https://doi.org/10.1016/j.ymssp.2015.05.027.

11. Lederman, G., et al., Track-monitoring from the dynamic response of an operational train. Mechanical Systems and Signal Processing, 2017. 87: p. 1-16, https://doi.org/10.1016/j.ymssp.2016.06.041.

12. Quirke, P., et al., Drive-by detection of railway track stiffness variation using in-service vehicles. Proceedings of the Institution of Mechanical Engineers, Part F: Journal of Rail and Rapid Transit, 2017. 231(4): p. 498-514

13. Shen, C., R. Dollevoet, and Z. Li, Fast and robust identification of railway track stiffness from simple field measurement. Mechanical Systems and Signal Processing, 2021. 152: p. 107431, https://doi.org/10.1016/j.ymssp.2020.107431.

14. Sun, X., et al., On-board detection of longitudinal track irregularity via axle box acceleration in HSR. IEEE Access, 2021. 9: p. 14025-14037

15. Traquinho, N., et al., Damage Identification for Railway Tracks Using Onboard Monitoring Systems in In-Service Vehicles and Data Science. Machines, 2023. 11(10): p. 981

16. Rizos, D., R. Naseri, and B. Gedney, Rapid Detection of Track Changes From Onboard Data Acquisition Records. 2024.

17. Naseri, R., et al., A Hybrid Signal Processing Approach for Rail Surface Irregularity Detection Using Onboard Axle Box Acceleration Sensors. Available at SSRN 4930311.

18. (FRA), F.R.A. Track Research Overview. [online] Available at: https://railroads.fra.dot.gov/program-areas/track-and-structures/track-research-overview.

19. (FRA), F.R.A. Automated Track Inspection Program (ATIP) Overview. [online] Available at: https://railroads.dot.gov/railroad-safety/divisions/track/atip-overview.

21. Liu, X., T. Turla, and Z. Zhang, Accident-cause-specific risk analysis of rail transport of hazardous materials. Transportation research record, 2018. 2672 (10): p. 176-187.

20. (FRA), F.R.A., Research, Development, and Technology Strategic Plan 2020-2024. [pdf] Available at: https://railroads.dot.gov/sites/fra.dot.gov/files/2020-07/Strategic%20Plan%202020-2024-A.pdf. 2024.

22. Liu, X., C.P. Barkan, and M.R. Saat, Analysis of derailments by accident cause: evaluating railroad track. Transportation research record, 2011. vol. 2261 (1): p. 178-185.

23. Administration, F.R., Accident data as reported by railroads. Available from: https://railroads.dot.gov/accident-and-incident-reporting/overview-reports/accident-data-reported-railroads.

24. Dahlberg, T., Railway track stiffness variations-consequences and countermeasures. 2010.

25. Morales-Ivorra, S., et al., Derailment risk and dynamics of railway vehicles in curved tracks: Analysis of the effect of failed fasteners. Journal of Modern Transportation, 2016. 24: p. 38-47.

26. Soufiane, K., A.M. Zarembski, and J.W. Palese, The contribution of crosstie condition as represented by local track stiffness to the wheel load distribution. Transportation Infrastructure Geotechnology, 2023. 10(6): p. 1321-1344.

27. Noppharat, S., et al., Dynamic train-track interactions over track stiffness discontinuities in railway track transitions mitigated by resilient materials. Innovative Infrastructure Solutions, 2024. 9(8): p. 322.

28. Ngamkhanong, C., et al., Evaluation of lateral stability of railway tracks due to ballast degradation. Construction and Building Materials, 2021. 278: p. 122342.

29. Zakeri, J.A. and B. Mirfattahi, Field investigation on the lateral resistance of railway tracks with frictional sleepers. IOP Conference Series: Materials Science and Engineering, 2020. 671(1): p. 012125.

30. FRA, Track Buckling Prevention: Theory, Safety Concepts, and Applications. 2013.

31. Qian, Y.R., Dimitris; Naseri, Reza; Data, Arya, Intelligent Risk Assessment and Prediction System (i-RAPS). 2023.

32. Naseri, R., B.L. Gedney, and D.C. Rizos, Onboard track change detection through a hybrid signal processing. To be submitted, 2025.

33. Naseri, R.G., Brennan L.; Rizos, Dimitrios C.; Qian, Yu;, R-VTI Simulations in Train Derailment Risk Assessment Studies. Vehicle System Dynamics (Submitted Manuscript), 2025.

34. Akujuobi, C.M., Wavelets and wavelet transform systems and their applications. Springer, 2022.

35. Pan, Y. and e. al., Structural health monitoring and assessment using wavelet packet energy spectrum. Safety Science, 2019. 120: p. 652-665.

36. Track Safety Standards Compliance Manual. 2008, United States Department of Transportation: Washington, D.C.

37. Development of objective track quality indices. FRA Research Results: RR05-01, 2005.

38. Offenbacher, S. and e. al., Analyzing major track quality indices and introducing a universally applicable TQI. Applied Science, 2020. 10 (23): p. 84-90.

What is claimed is:

1. Method for railway track condition monitoring of a rail system, comprising:
collecting field data while a railcar is in motion along a track in a rail system using at least one accelerometer attached to at least one railcar axle box of the railcar while synchronously recording associated GPS information of the railcar; and
processing the collected field data for dynamic response analysis using hybrid signal processing for detecting track stiffness changes in the rail system.

2. The method according to claim 1, further comprising identifying and classifying the track stiffness changes based on the dynamic response analysis.

3. The method according to claim 1, wherein the hybrid signal processing includes a multi-stage process including Wavelet Packet Analysis (WPA) and the Hilbert-Huang Transform (HHT).

4. The method according to claim 1, wherein the hybrid signal processing includes a multi-stage process integrating Wavelet Packet Analysis (WPA), Empirical Mode Decomposition (EMD), and the Hilbert Transform (HT).

5. The method according to claim 4, wherein the hybrid signal processing includes using WPA to analyze non-stationary signals from the collected field data across multiple frequency bands, to provide detailed time-frequency resolution for high resolution identifying of localized events.

6. The method according to claim 5, wherein the hybrid signal processing includes using EMD to refine output from the WPA by decomposing it into a finite number of Intrinsic Mode Functions (IMFs), as oscillatory components with localized time-frequency properties.

7. The method according to claim 6, wherein the hybrid signal processing includes applying HT to the IMFs derived from EMD to calculate instantaneous frequency and amplitude, for precise localization and characterization of the localized events within the non-stationary signals.

8. The method according to claim 2, further comprising only communicating information associated with the track stiffness changes from the processing for storage and for the identifying and the classifying.

9. The method according to claim 1, wherein the hybrid signal processing uses an adaptive window size to examine the track stiffness along the length of the collected field data, so that track stiffness changes are determined as changes relative to a historical baseline for the rail system.

10. The method according to claim 2, wherein identifying and classifying track stiffness changes includes identifying at least one of spatial stiffness variations, temporal stiffness variations, and severity levels.

11. The method according to claim 10, wherein identifying and classifying track stiffness changes includes identifying at least one underlying source of the track stiffness changes.

12. The method according to claim 1, wherein the at least one accelerometer provides data associated with multiple axes of movement for track stiffness change detection in at least vertical and/or lateral directions.

13. A detection system for the identification of Rail Surface Spot Irregularities (RSSI) of a rail system, comprising:
at least one accelerometer attached to at least one railcar axle box of a railcar for collecting Axle Box Acceleration (ABA) field data obtained from the at least one railcar axle box while the associated railcar is in motion along a track in a rail system; and
one or more processors programmed for
synchronously recording associated railcar GPS information, and
processing the collected ABA field data for dynamic response analysis using hybrid signal processing for detecting track stiffness changes in the rail system.

14. The detection system according to claim 13, wherein the one or more processors are further programmed for identifying and classifying the track stiffness changes based on the dynamic response analysis.

15. The detection system according to claim 13, wherein the hybrid signal processing includes a multi-stage process including Wavelet Packet Analysis (WPA) and the Hilbert-Huang Transform (HHT).

16. The detection system according to claim 13, wherein the hybrid signal processing includes a multi-stage process integrating Wavelet Packet Analysis (WPA), Empirical Mode Decomposition (EMD), and the Hilbert Transform (HT).

17. The detection system according to claim 16, wherein the hybrid signal processing includes using WPA to analyze non-stationary signals from the collected field data across multiple frequency bands, to provide detailed time-frequency resolution for high resolution identifying of localized events.

18. The detection system according to claim 17, wherein the hybrid signal processing includes using EMD, to refine output from the WPA by decomposing it into a finite number of Intrinsic Mode Functions (IMFs), as oscillatory components with localized time-frequency properties.

19. The detection system according to claim 18, wherein the hybrid signal processing includes applying HT to the IMFs derived from EMD, to calculate instantaneous frequency and amplitude, for precise localization and characterization of the localized events within the non-stationary signals.

20. The detection system according to claim 14, wherein the one or more processors are further programmed for only storing and communicating information associated with the track stiffness changes.

21. The detection system according to claim 13, wherein the hybrid signal processing uses an adaptive window size to examine track strength along the length of the collected field data, so that the track stiffness changes are determined as changes relative to a historical baseline for the rail system.

22. The detection system according to claim 14, wherein identifying and classifying track stiffness changes includes identifying at least one of spatial stiffness variations, temporal stiffness variations, and severity levels.

23. The detection system according to claim 22, wherein identifying and classifying track stiffness changes identifying at least one underlying source of the track stiffness changes.

24. The detection system according to claim 13, wherein the at least one accelerometer provides data associated with multiple axes of movement for track stiffness change detection in at least vertical and/or lateral directions.
